(19) United States
(12) Patent Application Publication
(10) Pub. No.: US 2023/0197333 A1
(43) Pub. Date: Jun. 22, 2023

(54) COIL COMPONENT

(71) Applicant: SAMSUNG ELECTRO-MECHANICS CO., LTD., Suwon-si (KR)

(72) Inventors: Chan Yoon, Suwon-si (KR); Dong Hwan Lee, Suwon-si (KR); Dong Jin Lee, Suwon-si (KR); Boum Seock Kim, Suwon-si, Gyeonggi-do (KR)

(73) Assignee: SAMSUNG ELECTRO-MECHANICS CO., LTD., Suwon-si (KR)

(21) Appl. No.: 18/072,916

(22) Filed: Dec. 1, 2022

(30) Foreign Application Priority Data
Dec. 20, 2021 (KR) 10-2021-0182707
Jul. 20, 2022 (KR) 10-2022-0089664

(51) Int. Cl. H01F 27/30; H01F 27/29; H01F 27/28

(52) U.S. Cl. CPC H01F 27/306; H01F 27/29; H01F 27/2823; H01F 27/24

(57) ABSTRACT

A coil component includes a body including opposing first and second side surfaces and opposing third and fourth side surfaces, a first coil portion disposed in the body, and including a first winding portion and first and second extension portions connected to the first winding portion, a second coil portion disposed in the body, and including a second winding portion disposed between the first side surface and the first winding portion, and third and fourth extension portions connected to the second winding portion, first and second external electrodes disposed on the body and respectively connected to the first and second extension portions, and third and fourth external electrodes disposed on the body and respectively connected to the third and fourth extension portions. The first extension portion of the first coil portion is disposed between the second winding portion and one of the third and fourth side surfaces.

### CROSS-REFERENCE TO RELATED APPLICATION(S)

This application claims benefit of priority to Korean Patent Application No. 10-2021-0182707 filed on Dec. 20, 2021 and Korean Patent Application No. 10-2022-0089664 filed on Jul. 20, 2022 in the Korean Intellectual Property Office, the disclosures of which are incorporated herein by reference in their entireties.

### TECHNICAL FIELD

The present disclosure relates to a coil component.

### BACKGROUND

With the miniaturization and thinning of electronic devices such as digital TVs, mobile phones, and notebook computers, there is need for the miniaturization and thinning of coil components applied to such electronic devices, and in order to meet this need, research and development of various winding-type or thin film-type coil components are actively progressing.

A major issue with the miniaturization and thinning of coil components is to realize the same characteristics as those of existing coil components, despite the miniaturization and thinning thereof. In order to satisfy these needs, a ratio of a magnetic material in a core in which the magnetic material is charged should be increased, but there is a limit to increasing the ratio due to changes in frequency characteristics according to strength and insulation of a body of an inductor.

Meanwhile, demand for an array-type coil component having an advantage of reducing a mounting area of the coil component is increasing. The array-type coil component may be a non-coupled inductor type, a coupled inductor type, or a mixture of the above types, according to a coupling coefficient or mutual inductance between a plurality of coil portions. In this case, the non-coupled inductor should have a low coupling coefficient (k) between the plurality of coil portions, and a distance therebetween may increase to lower a coupling coefficient therebetween. However, when the distance between the coil portions increases, a size of a component may also be increased, which may make it difficult to miniaturize the component.

### SUMMARY

An aspect of the present disclosure is to realize a coil component in the form of an inductor array, suitable for miniaturization while effectively lowering a coupling coefficient between a plurality of coil portions.

According to an aspect of the present disclosure, a coil component includes a body including first and second side surfaces perpendicular to a first direction while opposing each other, with third and fourth side surfaces opposing each other while connecting the first and second side surfaces, a first coil portion disposed in the body, and including a first winding portion as well as first and second extension portions, respectively connected to one end and the other end of the first winding portion, a second coil portion disposed in the body, and including a second winding portion disposed between the first side surface and the first winding portion, and third and fourth extension portions respectively connected to one end and the other end of the second winding portion, first and second external electrodes disposed on the body and respectively connected to the first and second extension portions, and third and fourth external electrodes disposed on the body and respectively connected to the third and fourth extension portions. The first extension portion of the first coil portion is disposed between the second winding portion and one of the third and fourth side surfaces, and is connected to the first external electrode on at least one of the first side surface and the third side surface.

In an embodiment, a second direction, which is perpendicular to the third side surface and the fourth side surface, may be perpendicular to the first direction.

In an embodiment, the first extension portion and the second winding portion may be disposed in the second direction.

In an embodiment, based on current flow of the first coil portion from the first extension portion toward the second extension portion, and current flow of the second coil portion from the third extension portion toward the fourth extension portion, positive coupling between the first coil portion and the second coil portion may occur in a first region including at least a region between the first and second winding portions.

In an embodiment, based on current flow of the first coil portion from the first extension portion toward the second extension portion, and current flow of the second coil portion from the third extension portion toward the fourth extension portion, negative coupling between the first coil portion and the second coil portion may occur in a second region including at least a region between the first extension portion and the second winding portion.

In an embodiment, based on current flow of the first coil portion from the first extension portion toward the second extension portion, and current flow of the second coil portion toward the fourth extension portion from the third extension portion, coupling between the first coil portion and the second coil portion opposite to coupling occurring in a second region including at least a region between the first extension portion and the second winding portion may occur in a first region including at least a region between the first and second winding portions.

In an embodiment, an interval between the first winding portion and the second winding portion in the first region may be wider than an interval between the first extension portion and the second winding portion in the second region.

In an embodiment, an interval between the first extension portion and the second winding portion in the second region may be substantially equal to an interval between adjacent turns in the second winding portion.

In an embodiment, in the second region, the first extension portion may have an inner side surface having a shape conforming to a shape of an external side surface adjacent to the second winding portion.

In an embodiment, the first extension portion may have a shape conforming to both a curved region and a planar region on the external side surface adjacent to the second winding portion.

In an embodiment, the fourth extension portion may extend to at least one of the second side surface and the fourth side surface, and may be disposed between the first winding portion and another of the third and fourth side surfaces.

In an embodiment, the fourth extension portion and the first winding portion may be disposed in the second direction.

In an embodiment, based on current flow of the first coil portion from the first extension portion toward the second extension portion, and current flow of the second coil portion from the third extension portion toward the fourth extension portion, negative coupling between the first coil portion and the second coil portion may occur in a first region including at least a region between the first and second winding portions.

In an embodiment, positive coupling between the first coil portion and the second coil portion may occur in a second region including at least a region between the first extension portion and the second winding portion.

In an embodiment, positive coupling between the first coil portion and the second coil portion may occur in a third region including at least a region between the fourth extension portion and the first winding portion.

In an embodiment, negative coupling between the first coil portion and the second coil portion may occur in a third region including at least a region between the fourth extension portion and the first winding portion.

In an embodiment, the coil component may further include a support member supporting the first and second coil portions, wherein the first coil portion may be disposed on upper and lower surfaces of the support member, and the second coil portion may be disposed on the upper and lower surfaces of the support member.

In an embodiment, the first and third extension portions may be disposed on the upper surface of the support member, and the second and fourth extension portions may be disposed on the lower surface of the support member.

In an embodiment, the second extension portion may be connected to the second external electrode on at least one of the first side surface and the third side surface of the body.

In an embodiment, the third extension portion may be connected to the third external electrode on at least one of the first side surface and the fourth side surface of the body, and the fourth extension portion may be connected to the fourth external electrode on at least one of the second side surface and the fourth side surface of the body.

In an embodiment, lengths of the first and second extension portions may be different from each other in the first direction.

In an embodiment, in the first and second coil portions, those disposed on the upper surface of the support member may be symmetrical to those disposed on the lower surface of the support member, based on the support member.

In an embodiment, the first and second coil portions may be disposed on at least three levels within the body.

In an embodiment, the at least three levels may include first to third levels, wherein the second level may be located between the first level and the third level, the first coil portion is disposed on the first and second levels, and the second coil portion may be disposed on the second and third levels.

According to another aspect of the present disclosure, a coil component includes a body including first and second side surfaces perpendicular to a first direction while opposing each other, with third and fourth side surfaces opposing each other while connecting the first and second side surfaces, a first coil portion disposed in the body, including a first winding portion as well as first and second extension portions, respectively connected to one end and the other end of the first winding portion, a second coil portion disposed in the body, and including a second winding portion disposed between the first winding portion and the first side surface, and third and fourth extension portions respectively connected to one end and the other end of the second winding portion, first and second external electrodes disposed on the body and respectively connected to the first and second extension portions, and third and fourth external electrodes disposed on the body and respectively connected to the third and fourth extension portions. The first extension portion extends toward at least one of the first side surface and the third side surface, to be connected to the first external electrode. Based on current flow of the first coil portion from the first extension portion toward the second extension portion, and current flow of the second coil portion from the third extension portion toward the fourth extension portion, opposite coupling between the first coil portion and the second coil portion occurs in at least two regions among a plurality of regions between the first and second coil portions.

In an embodiment, coupling between the first and second coil portions opposite to coupling occurring in a second region including at least a region between the first extension portion and the second winding portion may occur in a first region including at least a region between the first and second winding portions.

According to another aspect of the present disclosure, a coil component includes a body; a first coil portion disposed in the body and including a first winding portion; a second coil portion disposed in the body and including a second winding portion; first and second external electrodes disposed on exterior surfaces of the body and connected to the first coil portion; and third and fourth external electrodes disposed on the exterior surfaces the body and connected to the second coil portion. One of the first and second external electrodes is closer to the second winding portion than one of the third and fourth external electrodes and farther to the first winding portion than the one of the third and fourth external electrodes. Another of the first and second external electrodes is closer to the first winding portion than another of the third and fourth external electrodes and farther to the second winding portion than the another of the third and fourth external electrodes.

In an embodiment, the body may include first and second side surfaces opposing each other in a first direction, and third and fourth side surfaces opposing each other in a second direction and connecting the first and second side surfaces. The second winding portion may be disposed between the first winding portion and the first side surface, and the first winding portion may be disposed between the second winding portion and the second side surface.

In an embodiment, the first and second external electrodes may be closer to one of the third and fourth surfaces than the third and fourth external electrodes.

In an embodiment, the coil component may further include a support member, the first winding portion may include one winding portion disposed on an upper surface of the support member and another winding portion disposed on a lower surface of the support member and connected to the one winding portion of the first winding portion, and the second winding portion may include one winding portion disposed on the upper surface of the support member and another winding portion disposed on the lower surface of the support member and connected to the one winding portion of the second winding portion.

According to another aspect of the present disclosure, a coil component includes a body including first and second side surfaces opposing each other and third and fourth side surfaces opposing each other while connecting the first and second side surfaces; a first coil portion disposed in the body and including a first winding portion; a second coil portion disposed in the body and including a second winding portion disposed between the first side surface and the first winding portion; first and second external electrodes disposed on the body and connected to the first coil portion; and third and fourth external electrodes disposed on the body and connected to the second coil portion. A path along the first coil portion from one of the first and second external electrodes to another of the first and second external electrodes, and a path along the second coil portion from one of the third and fourth external electrodes to another of the third and fourth external electrodes, are in a same direction at a region between center portions of the first and second winding portions and are in opposite directions at a region between the center portion of one of the first and second winding portions and one of the third and fourth surfaces.

In an embodiment, the first and second external electrodes may be closer to one of the third and fourth surfaces than the third and fourth external electrodes.

In an embodiment, the first and third external electrodes may be closer to the first side surface than the second and fourth external electrodes.

In an embodiment, the coil component may further include a support member, the first winding portion may include one winding portion disposed on an upper surface of the support member and another winding portion disposed on a lower surface of the support member and connected to the one winding portion of the first winding portion, and the second winding portion may include one winding portion disposed on the upper surface of the support member and another winding portion disposed on the lower surface of the support member and connected to the one winding portion of the second winding portion.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a transparent perspective view schematically illustrating a coil component of an embodiment of the present disclosure.

FIGS. 2 and 3 are plan views of the coil portion of FIG. 1, viewed from above, and correspond to an upper coil portion and a lower coil portion, respectively, with respect to a support member.

FIGS. 4 and 5 are plan views of a first coil portion, viewed from above, and correspond to an upper coil portion and a lower coil portion with respect to a support member, respectively.

FIGS. 6 to 11 illustrate coil portions according to modified examples.

FIG. 12 is a transparent perspective view schematically illustrating a conventional coil component.

FIGS. 13 to 26 illustrate coil portions according to modified examples.

### DETAILED DESCRIPTION

Hereinafter, embodiments of the present disclosure will be described with reference to specific embodiments and the accompanying drawings. However, an embodiment of the present disclosure may be modified to have various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

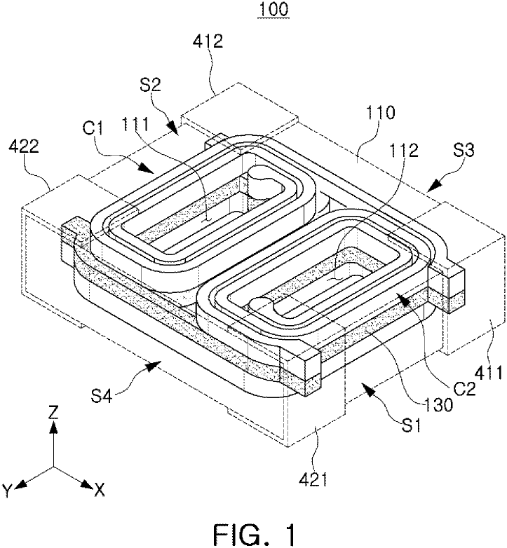

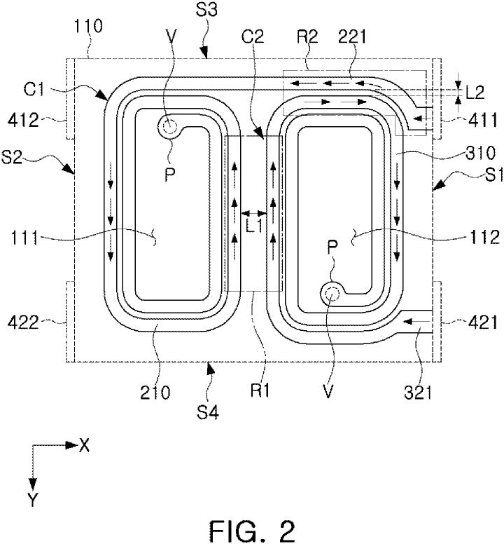

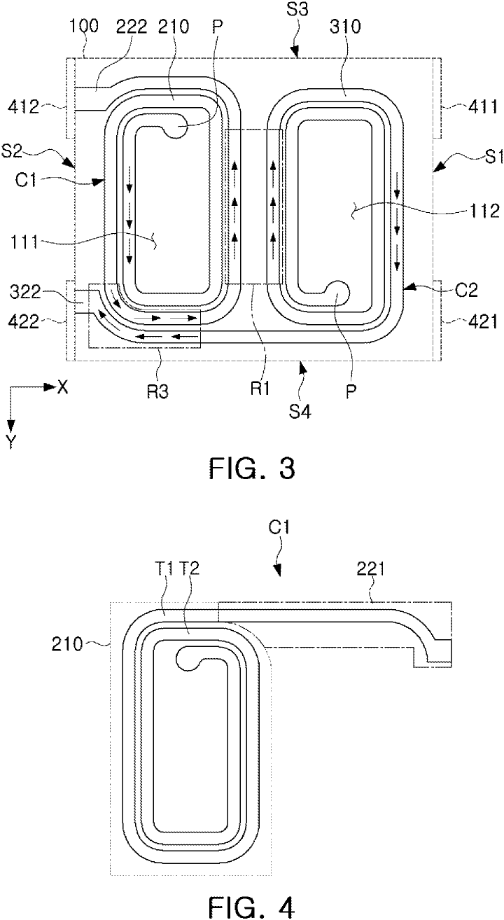

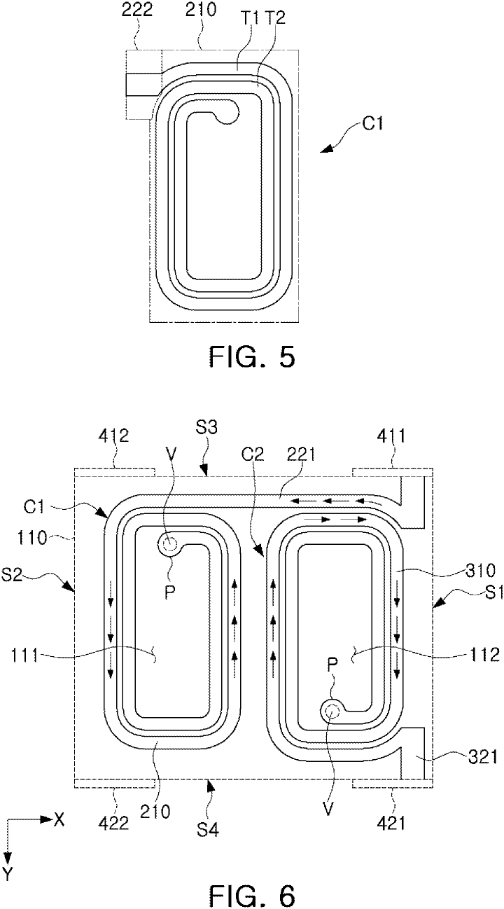

FIG. 1 is a transparent perspective view schematically illustrating a coil component of an embodiment of the present disclosure. FIGS. 2 and 3 are plan views of the coil portion of FIG. 1, viewed from above, and correspond to an upper coil portion and a lower coil portion, respectively, with respect to a support member. In FIGS. 2 and 3, components other than the coil portions may be indicated by dotted lines, and the supporting member will be omitted. FIGS. 4 and 5 are plan views of a first coil portion, viewed from above, and correspond to an upper coil portion and a lower coil portion with respect to a support member, respectively. The following coil components may be used as a power inductor, a high frequency inductor, a general bead, a high frequency (GHz) bead, a common mode filter, and the like.

Referring to FIGS. 1 to 3, a coil component 100 according to an embodiment of the present disclosure includes a body 110, a first coil portion C1, a second coil portion C2, and external electrodes 411, 412, 421, and 422, and an inductor array form may be implemented by a plurality of coil portions C1 and C2. In this case, a first extension portion 221 of the first coil portion C1 may be disposed adjacently to a second winding portion 310 of the second coil portion C2, may extend to at least one of a first side surface S1 and a third side surface S3 of the body 110, as will be described later, and effectively adjust a coupling coefficient of the first and second coil portions, C1 and C2. Hereinafter, main elements comprising the coil component 100 of the present embodiment will be described.

The first and second coil portions C1 and C2 and the like may be disposed in the body 110, and an overall appearance of the coil component 100 may be achieved. The body 110 may include a first side surface S1 and a second side surface S2 disposed perpendicularly to a first direction (an X-direction) while facing each other. The body 110 may include a third side surface S3 and a fourth side surface S4, and the third side surface S3 and the fourth side surface S4 may face each other while connecting the first side surface S1 and the second side surface S2. In this case, if a direction perpendicularly to the third side surface S3 and the fourth side surface S4 is referred to as a second direction (a Y-direction), the second direction (the Y-direction) may be perpendicularly to the first direction (the X-direction).

The body 110 may include an insulating resin and a magnetic material. Specifically, the body 110 may be formed by laminating one or more magnetic composite sheets in which a magnetic material is dispersed in an insulating resin. The magnetic material may be a ferrite powder particle or a metal magnetic powder particle. Examples of the ferrite powder particle may include at least one or more spinel type ferrites, such as Mg-Zn-based ferrite, Mn-Zn-based ferrite, Mn-Mg-based ferrite, Cu-Zn-based ferrite, Mg-Mn-Sr-based ferrite, Ni-Zn-based ferrite, and the like, hexagonal ferrites such as Ba-Zn-based ferrite, Ba-Mg-based ferrite, Ba-Ni-based ferrite, Ba-Co-based ferrite, Ba-Ni-Co-based ferrite, and the like, garnet type ferrites such as Y-based ferrite, and the like, and Li-based ferrites. The metal magnetic powder particle may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particle may be at least one or more of a pure iron powder, a Fe-Si-based alloy powder, a Fe-Si-Al-based alloy powder, a Fe-Ni-based alloy powder, a Fe-Ni-Mo-based alloy powder, a Fe-Ni-Mo-Cu-based alloy powder, a Fe-Co-based alloy powder, a Fe-Ni-Co-based alloy powder, a Fe-Cr-based alloy powder, a Fe-Cr-Si-based alloy powder, a Fe-Si-Cu-Nb-based alloy powder, a Fe-Ni-Cr-based alloy powder, and a Fe-Cr-Al-based alloy powder. The metal magnetic powder particle may be amorphous or crystalline. For example, the metal magnetic powder particle may be a Fe-Si-B-Cr-based amorphous alloy powder particle, but the present disclosure is not limited thereto. The ferrite powder particle and the metal magnetic powder particle may have an average diameter of about 0.1 µm to 30 µm, respectively, but are not limited thereto. The body 110 may include two or more types of magnetic materials dispersed in the resin. In this case, the term “different types of magnetic materials” means that magnetic materials dispersed in a resin are distinguishable from each other by at least one of an average diameter, a composition, a crystallinity, or a shape. The insulating resin may include an epoxy, a polyimide, a liquid crystal polymer, or the like, in a single form or in combined form, but the present disclosure is not limited thereto.

In relation to an example of the manufacturing method, the body 110 may be formed using a lamination method. Specifically, a plurality of unit stacks for manufacturing the body 110 may be prepared and stacked on upper and lower portions of the first and second coil portions C1 and C2. In this case, the unit stacks may be prepared as sheet types by mixing a magnetic particle, such as a metal or the like, and an organic material such as a thermosetting resin, a binder, a solvent, or the like, to form a slurry, applying the slurry to a carrier film by a doctor blade method, to a thickness of several tens of µm, and drying the same. Therefore, the unit stacks may be manufactured in a form in which the magnetic particle is dispersed in the thermosetting resin such as an epoxy resin, polyimide, or the like.

The first coil portion C1 may be disposed in the body 110, and may have a first winding portion 210 and first and second extension portions 221 and 222 respectively connected to one end and the other end of the first winding portion 210. The first winding portion 210 may form at least one turn, and in this case, the one end and the other end of the first winding portion 210 may be defined to include a region forming a substantial turn. Specifically, as illustrated in FIGS. 4 and 5, an outermost turn T1 of the first winding portion 210 may be maintained at a substantially constant interval from an inner turn T2 adjacent thereto, the first winding portion 210 may be defined up to a region in which the constant interval is maintained, and the first extension portion 221 or the second extension portion 222 may be defined from a region in which an interval between the outermost turn T1 and the inner turn T2 increases.

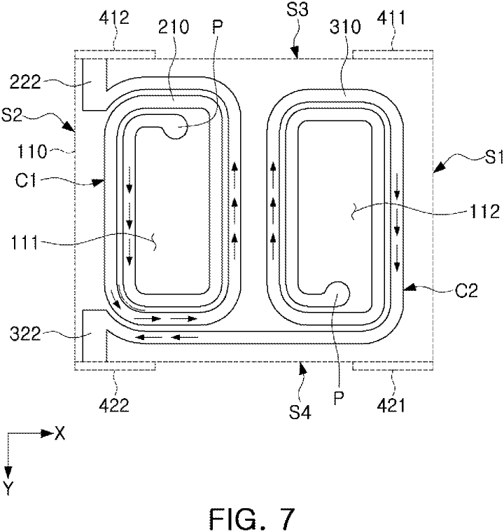

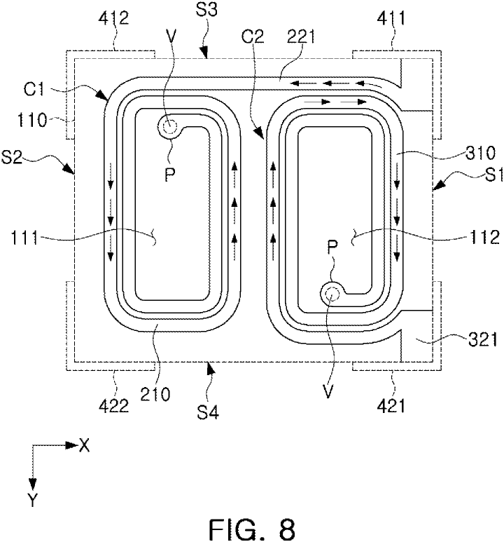

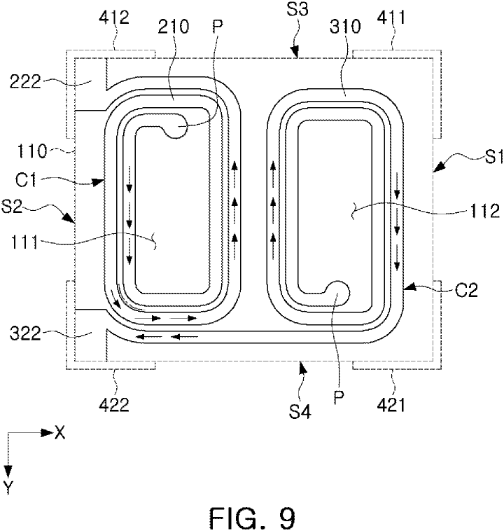

The first coil portion C1 may be disposed on both a first surface (an upper surface, based on the drawings) and a second surface (a lower surface, based on the drawings) of the support member 130, and a portion disposed on the first surface may be referred to as an upper coil portion (FIG. 2), and a portion disposed on the second surface may be referred to as a lower coil portion (FIG. 3). To connect the upper and lower coil portions, the first coil portion C1 may include a pad region P, and the pad region P may be connected to a conductive via V passing through the support member 130. Moreover, the first extension portion 221 disposed on the upper surface of the support member 130 may be exposed from at least one of the first side surface S1 and the third side surface S3 of the body 110, to be connected to a first external electrode 411. In the present embodiment, although the first extension portion 221 is illustrated as having a structure in which the first extension portion 221 is exposed from the first side surface S1 of the body 110, as in the modified examples of FIGS. 6 and 7, the first extension portion 221 may be exposed from the third side surface S3 of the body 110, and thus the first external electrode 411 may be disposed on the third side surface S3. In addition, the first extension portion 221 may be exposed from both the first side surface S1 and the third side surface S3, as in the modified examples of FIGS. 8 and 9, and thus the first external electrode 411 may be formed on both the first and third side surfaces S1 and S3.

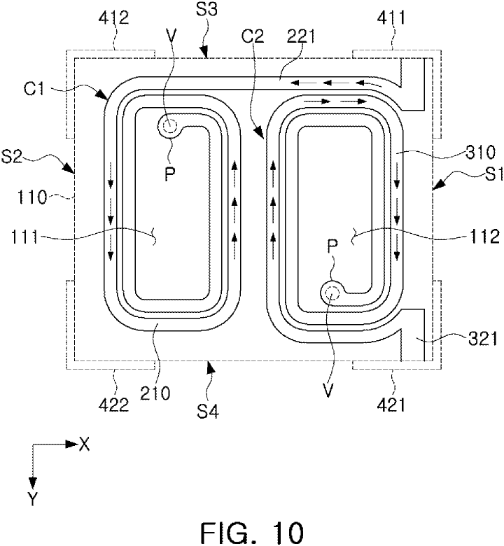

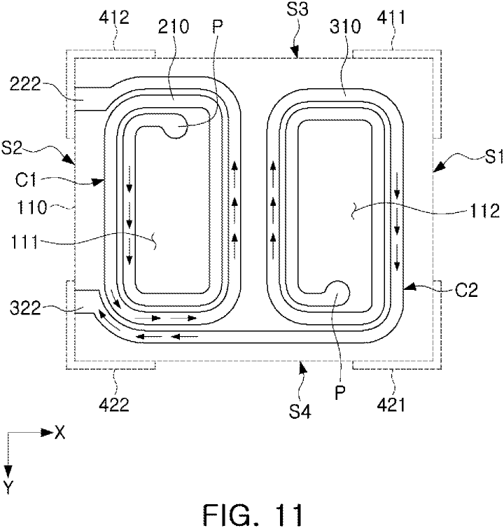

The second extension portion 222 disposed on the lower surface of the support member 130 may be exposed from at least one of the second side surface S2 and the third side surface S3 of the body 110, to be connected to a second external electrode 412. In the present embodiment, although the second extension portion 222 is illustrated to have a structure in which the second extension portion 222 is exposed from the second side surface S2 of the body 110, as in the modified examples of FIGS. 6 and 7, the second extension portion 222 may be exposed from the third side surface S3 of the body 110, and thus the second external electrode 412 may be disposed on the third side surface S3. In addition, the second extension portion 222 may be exposed from both the second side surface S2 and the third side surface S3, as in the modified examples of FIGS. 8 and 9, and thus the second external electrode 412 may be formed on both the second and third side surfaces S2 and S3. A method of connecting the first and second extension portions 221 and 222 and the first and second external electrodes 411 and 412 may be further modified, for example, as in the modified examples of FIGS. 10 and 11. The first extension portion 221 may be exposed from the third side surface S3, and the second extension portion 222 may be exposed from the second side surface S2, and vice versa. In this case, the first external electrode 411 may be closer to the second winding portion 310 than the fourth external electrode 422 and farther to the first winding portion 210 than the fourth external electrode 422, and the second external electrode 412 may be closer to the first winding portion 210 than the third external electrode 421 and farther to the second winding portion 310 than the third external electrode 421. Various methods of connecting the first and second extension portions 221 and 222 and the first and second external electrodes 411 and 412 may be employed in the following embodiments.

Referring back to FIGS. 1 to 3, the first extension portion 221 and the second extension portion 222 may have different lengths in the first direction (the X-direction). In the first coil portion C1, the first extension portion 221 and the second extension portion 222 may be plating patterns formed using a plating process used in the art, for example, pattern plating, anisotropic plating, isotropic plating, or the like, and a plurality of processes among these processes may be used. Thus, the first extension portion 221 and the second extension portion 222 may be formed to have a multilayer structure.

The second coil portion C2 may be disposed in the body 110, and may have a second winding portion 310, and third and fourth extension portions 321 and 322 respectively connected to one end and the other end of the second winding portion 310. The second winding portion 310 may be disposed closer to the first side surface S1, as compared to the first winding portion 210, while being adjacent to the first winding portion 210 in the first direction (the X-direction) in the body 110. For example, the second winding portion 310, among the first winding portion 210 and the second winding portion 310, may be disposed closer to the first side surface S1. The second winding portion 310 may form at least one turn, and in this case, the one end and the other end of the second winding portion 310 may be defined to include a region forming a substantial turn. The definitions of the first winding portion 210 and the first and second extension portions 221 and 222 described in the first coil portion C1 may also be applied to the second coil portion C2. For example, an outermost turn of the second winding portion 310 may be maintained at a substantially constant interval from an inner turn adjacent thereto, and the second winding portion 310 may be defined up to a region in which the constant interval is maintained, and the third extension portion 321 or the fourth extension portion 322 may be defined from a region in which an interval between the outermost turn and the inner turn increases.

Also, like the first coil portion C1, the second coil portion C2 may be disposed on both the first surface (the upper surface, based on the drawings) and the second surface (the lower surface, based on the drawings) of the support member 130, and a portion disposed on the first surface may be referred to as an upper coil portion (FIG. 2), and a portion disposed on the second surface may be referred to as a lower coil portion (FIG. 3). To connect the upper and lower coil portions, the second coil portion C2 may include a pad region P, and the pad region P may be connected to a conductive via V passing through the support member 130. Moreover, the third extension portion 321 disposed on the upper surface of the support member 130 may be exposed from at least one of the first side surface S1 and the fourth side surface S4 of the body 110, to be connected to a third external electrode 421. In the present embodiment, although the third extension portion 321 is illustrated to have a structure in which the third extension portion 321 is exposed from the first side surface S1 of the body 110, as in the modified examples of FIGS. 6 and 7, the third extension portion 321 may be exposed from the fourth side surface S4 of 110, and thus the third external electrode 421 may be disposed on the fourth side surface S4. In addition, the third extension portion 321 may be exposed from both the first side surface S1 and the fourth side surface S4, as in the modified examples of FIGS. 8 and 9, and thus the third external electrode 421 may be formed on both the first and fourth side surfaces S1 and S4.

The fourth extension portion 322 disposed on the lower surface of the support member 130 may be exposed from at least one of the second side surface S2 and the fourth side surface S4 of the body 110, to be connected to a fourth external electrode 422. In the present embodiment, the fourth extension portion 322 is illustrated as having a structure in which the fourth extension portion 322 is exposed from the second side surface S2 of the body 110, as in the modified examples of FIGS. 6 and 7, the fourth extension portion 322 may be exposed from the fourth side surface S4 of the body 110, and thus the fourth external electrode 422 may be formed on the fourth side surface S4. In addition, the fourth extension portion 322 may be exposed from both the second side surface S2 and the fourth side surface S4, as in the modified examples of FIGS. 8 and 9, and thus the fourth external electrode 422 may be formed on both the second and fourth side surfaces S2 and S4. A method of connecting the third and fourth extension portions 321 and 322 and the third and fourth external electrodes 421 and 422 may be further modified, for example, as in the modified examples of FIGS. 10 and 11. The third extension portion 321 may be exposed from the fourth side surface S4, and the fourth extension portion 322 may be exposed from the second side surface S2, and vice versa. In addition, various methods of connecting the third and fourth extension portions 321 and 322 and the third and fourth external electrodes 421 and 422 may be employed in the following embodiments.

Referring back to FIGS. 1 to 3, as illustrated, the third and fourth extension portions 321 and 322 may have different lengths in the first direction (the X-direction). In the second coil portion C2, the third and fourth extension portions 321 and 322 may be plating patterns formed using a plating process used in the art, for example, pattern plating, anisotropic plating, isotropic plating, or the like, and a plurality of processes among these processes may be used. Thus, the third and fourth extension portions 321 and 322 may be formed to have a multilayer structure.

Examples of materials comprising the first and second coil portions C1 and C2 may be a conductive material such as copper (Cu), aluminum (Al), silver (Ag), tin (Sn), gold (Au), nickel (Ni), lead (Pb), titanium (Ti), chromium (Cr), or alloys thereof, but the present disclosure is not limited thereto. As illustrated in FIGS. 2 and 3, in the present embodiment, the first and second coil portions C1 and C2 may be symmetrical in the upper and lower portions with respect to the support member 130 as a whole. In this case, that the first and second coil portions C1 and C2 may be symmetrical as a whole means that the first and second coil portions C1 and C2 are not symmetrical, respectively, but, when the first and second coil portions C1 and C2 are viewed as a group, it means that such a group forms a symmetric structure. In such a symmetrical structure, when the first and second coil portions C1 and C2 are formed by a plating process on the upper and lower surfaces of the support member 130, plating dispersion may be minimized. In addition, although the present embodiment illustrates a structure in which two coil portions C1 and C2 are disposed in the body 110, other coil portions may be additionally disposed, in addition to the first and second coil portions C1 and C2, to form an inductor array as a whole.

The support member 130 may support the first and second coil portions C1 and C2, and may be formed of, for example, a polypropylene glycol (PPG) substrate, a ferrite substrate, a metal-based soft magnetic substrate, or the like. According to an embodiment, the support member 130 may not be provided. For example, when a coil having a winding structure is used, the support member 130 may not be separately required. As illustrated, a portion of the support member 130 may be penetrated to form a through-hole, and a material comprising the body 110 may be filled in the through-hole. Therefore, a first core portion 111 may be formed in the first coil portion C1, and a second core portion 112 may be formed in the second coil portion C2.

The first and second external electrodes 411 and 412 may be disposed on the body 110, and may be respectively connected to the first extension portion 221 and the second extension portion 222 of the first coil portion C1. In this case, the first and second external electrodes 411 and 412 may be respectively disposed on the first side surface S1 and the second side surface S2, and, as in the above-described modified example, may extend to the third side surface S3, or may be disposed only on the third side surface S3. The third and fourth external electrodes 421 and 422 may be disposed on the body 110, and may be respectively connected to the third extension portion 321 and the fourth extension portion 322 of the second coil portion C2. In this case, the third and fourth external electrodes 421 and 422 may be respectively disposed on the first side surface S1 and the second side surface S2 of the body 110, and, as in the above-described modified example, may extend to the fourth side surface S4, or may be disposed only on the fourth side surface S4.

In the present embodiment, a method of arranging the external electrodes 411, 412, 421, and 422 may be appropriately designed to have a region in which opposite coupling occurs due to current flow generated in the first and second coil portions C1 and C2. For example, as illustrated in FIGS. 1 to 3, the first and second external electrodes 411 and 412 may be disposed in positions facing each other on the first side surface S1 and the second side surface S2, respectively. Similarly, the third and fourth external electrodes 421 and 422 may be disposed at positions facing each other on the first side surface S1 and the second side surface S2, respectively. In addition, the fourth external electrode 422 may be disposed in a diagonal direction of the body 110 with respect to the first external electrode 411, e.g., in a direction connecting corners disposed distantly from each other in the body 110 based on FIG. 2. Similarly, the third external electrode 421 may be disposed in a diagonal direction of the body 110 with respect to the second external electrode 412.

The first to fourth external electrodes 411, 412, 421, and 422 may be formed using a paste containing a metal having excellent electrical conductivity, and the paste may be, for example, a conductive paste including nickel (Ni), copper (Cu), tin (Sn), silver (Ag), or the like alone, or alloys thereof or the like. In addition, a plating layer may be provided to cover each of the first to fourth external electrodes 411, 412, 421, and 422. In this case, the plating layer may include any one or more selected from the group consisting of nickel (Ni), copper (Cu), and tin (Sn), and, for example, a nickel (Ni) layer and a tin (Sn) layer may be formed therein sequentially.

In the present embodiment, the first extension portion 221 may extend to the first side surface S1, and may be disposed adjacently to the second winding portion 310, but, as in the above-described modified example, the first extension portion 221 may extend to the third side surface S3, instead of the first side surface S1, or to the first side surface S1 and the third side surface S3. In this case, the first extension portion 221 and the second winding portion 310 may be disposed adjacently to each other in the second direction (the Y-direction). The second coil portion C2 may also have a structure similar to that of the first coil portion C1, and the third extension portion 321 may extend to the second side surface S2, to be disposed adjacently to the first winding portion 210 in the second direction (the Y-direction). As the coil portions C1 and C2 and the external electrodes 411, 412, 421, and 422 have the above-described arrangement method, in operating the coil component 100, opposite coupling may occur the first and second coil portions C1 and C2, and magnitudes (absolute values) of coupling coefficients of the first and second coil portions C1 and C2 may decrease.

Specifically, based on current flow (directions indicated by arrows in FIGS. 2 and 3) of the first coil portion C1 from the first extension portion 221 toward the second extension portion 222, and current flow (directions indicated by arrows in FIGS. 2 and 3) of the second coil portion C2 from the third extension portion 321 toward the fourth extension portion 322, positive coupling, e.g., coupling by current flow in the same direction, may occur in a first region R1 adjacent to the first and second winding portions 210 and 310. In this case, negative coupling, e.g., coupling by current flow in opposite directions may occur in a second region R2 adjacent to the first extension portion 221 and the second winding portion 310. Similarly, in a third region R3 adjacent to the fourth extension portion 322 and the first winding portion 210, negative coupling may occur by current flow in opposite directions. As such, in the present embodiment, to lower a magnitude of a coupling coefficient, the first and second coil portions C1 and C2 may be designed to include regions R1, R2, and R3 in which opposite couplings may occur at the same time, and, as described above, while the first and second winding portions 210 and 310 may be disposed adjacently to each other in the first direction (the X-direction), the first extension portion 221 may correspond to a configuration disposed to extend to the first side surface S1 adjacent to the second winding portion 310. Hereinafter, a coupling method generated in the second region R2 adjacent to the first extension portion 221 and the second winding portion 310 will be mainly described, but the description thereof may also be applied to the third region R3. In one example, a path along the first coil portion C1 from the first external electrode 411 to the second external electrode 412 and a path along the second coil portion C2 from the third external electrode 421 to the fourth external electrode 422, may be in a same direction at a region R1 between center portions of the first and second winding portions 210 and 310 and may be in opposite directions at a region R2 or R3 between the center portion of one of the first and second winding portions 210 and 310 and one of the third and fourth surfaces S3 and S4.

Positive coupling does not always have to occur in the first region R1 and negative coupling does not always have to occur in the second region R2, and reverse coupling, e.g., negative coupling may occur in the first region R1 and positive coupling may occur in the second region R2. In general, the present embodiment may be extended to occurrence of coupling, opposite to that occurring in the second region R2, in the first region R1. When further extended, opposite coupling do not need to appear limited to only the first and second regions R1 and R2, and, based on current flow of the first coil portion C1 from the first extension portion 221 toward the second extension portion 222 and current flow of the second coil portion C2 from the third extension portion 321 toward the fourth extension portion 322, occurrence of opposite coupling in at least two regions of the first and second coil portions C1 and C2, among a plurality of regions adjacent to each other, may be included in the present embodiment. As such, since an effect of decreasing an absolute amount of coupling as a whole may be provided, as the adjacent regions R1, R2, and R3 exhibited by opposite coupling are present, magnitudes of coupling coefficients of the first and second coil portions C1 and C2 may be lowered. In this case, since it is not necessary to increase a distance between the first and second coil portions C1 and C2 to decrease the magnitudes of the coupling coefficients, it may be advantageous for miniaturization of the coil component 100.

In the present embodiment, an interval L1 between the first winding portion 210 and the second winding portion 310 in the first region R1 may be wider than an interval L2 between the first extension portion 221 and the second winding portion 310 in the second region R2. A length at which coupling occurs, in the first region R1 in which the first winding portion 210 and the second winding portion 310 are disposed adjacently to each other, may be relatively longer than a length at which coupling occurs, in the second region R2 in which the first extension portion 221 and the second winding portion 310 are disposed adjacently to each other. In this case, a coupling effect in the first region R1 may be relatively reduced by making the interval L1 in the first region R1 longer than the interval L2 in the second region R2, and an overall coupling reduction effect may thus be further improved. In this case, in the second region R2, the interval L2 between the first extension portion 221 and the second winding portion 310 may be narrow to be substantially equal to an interval between adjacent turns in the second winding portion 310, which corresponds to a shape suitable for miniaturization of the coil component 100. Also, in the second region R2, the first extension portion 221 may have an inner side surface having a shape that follows a shape of an external side surface adjacent to the second winding portion 310.

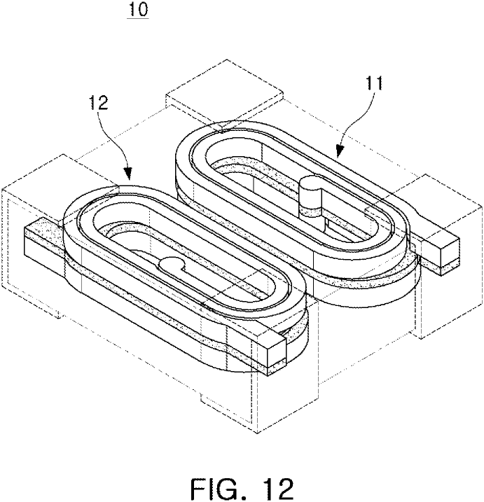

As described above, a magnitude of a coupling coefficient in the coupling structure of the inductor array proposed in the present embodiment, e.g., in a structure in which the first and second coil portions C1 and C2 have regions in which opposite coupling occurs, may be reduced, compared to a conventional inductor array, and the inventors of the present disclosure confirmed this through simulation results. FIG. 12 illustrates a coil component 10 according to a conventional structure, in which first and second coil portions 11 and 12 may be adjacent in one direction to promote one type of coupling in one region. As the simulation results, a coupling coefficient of the coil component having the structure of FIG. 12 was calculated to be about 7% (0.0702628). In comparison, a coupling coefficient of the coil component 100 according to the present embodiment having the above-described structure showed to be about 0.567% (0.0056734), a significantly lower result than the prior art, by which it can be understood that adjacent regions in which positive coupling and negative coupling occur are present.

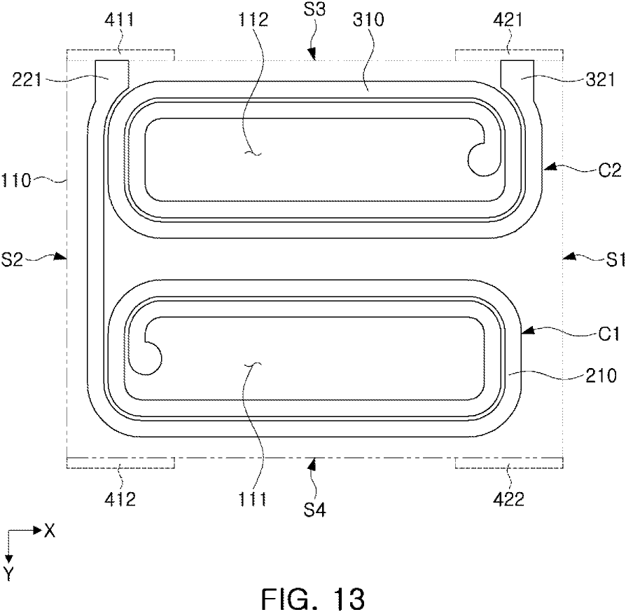

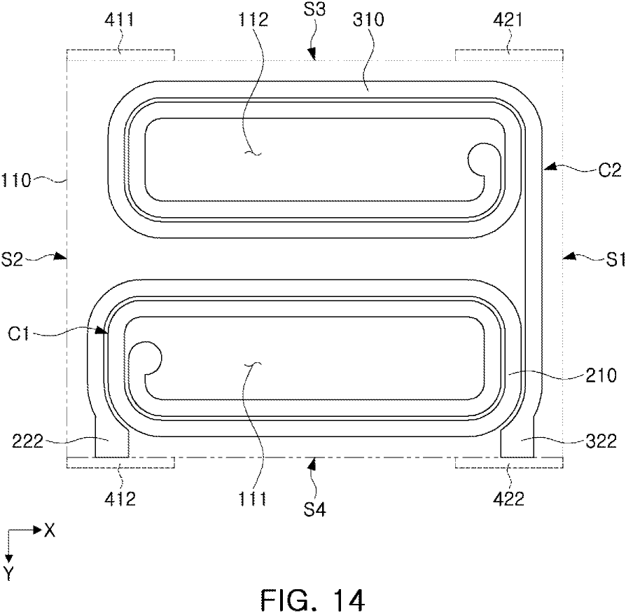

The first and second coil portions C1 and C2 may be disposed adjacently to each other in a direction, different from that of the above-described embodiment, which means that lengths of the body 110 are different from each other in the first direction (the X-direction) and in the second direction (the Y-direction). FIGS. 13 and 14 illustrate an upper coil portion and a lower coil portion, respectively, based on a support member, and as illustrated, first and second external electrodes 411 and 412 may be disposed on a third side surface S3 and a fourth side surface S4, respectively, and third and fourth external electrodes 421 and 422 may be disposed on the third side surface S3 and the fourth side surface S4, respectively. In addition, first and second winding portions 210 and 310 may be disposed adjacently to each other in the second direction (the Y-direction). Therefore, based on current flow of a first coil portion C1 from a first extension portion 221 toward a second extension portion 222 and current flow of a second coil portion C2 from a third extension portion 321 toward a fourth extension portion 322, coupling opposite to coupling occurring in a second region adjacent to the first extension portion 221 and the second winding portion 310 may occur in a first region adjacent to the first and second winding portions 210 and 310. Since names for a direction and a surface may be arbitrarily determined, only for the modified examples of FIGS. 13 and 14, a Y-direction may be referred to as a first direction, and surfaces perpendicularly to the Y-direction may be referred to as a first side surface and a second side surface, and, similarly, an X-direction may be referred to as a second direction, and surfaces perpendicularly to the X-direction may be referred to as a third side surface and a fourth side surface. The arrangement method illustrated in FIGS. 13 and 14 may also be applied to the following modified examples.

Hereinafter, various modifications of the present disclosure will be described.

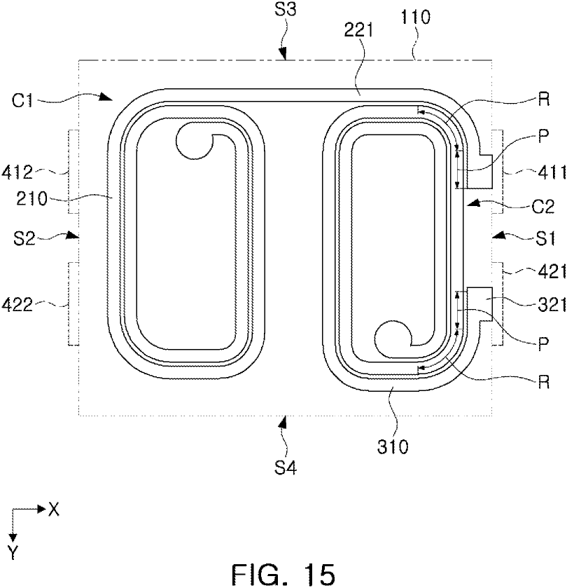

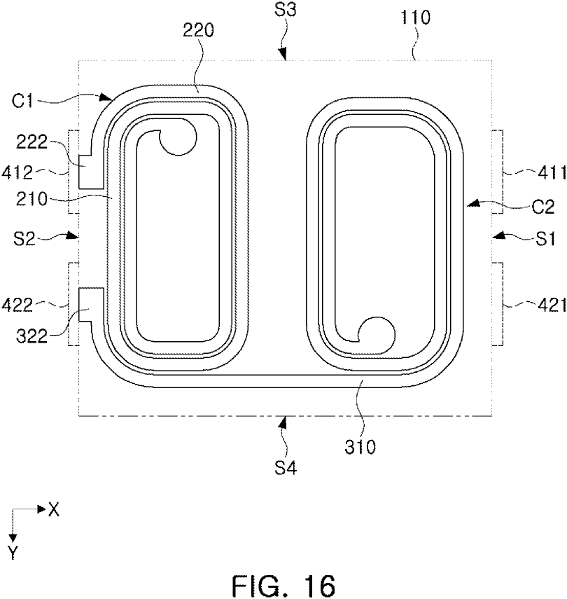

First, in a modified example of FIGS. 15 and 16, FIG. 15 illustrates an upper coil portion, and FIG. 16 illustrates a lower coil portion. In this modified example, first and second coil portions C1 and C2 may be different in view of shapes of extension portions 221, 222, 321, and 322, compared to the previous embodiments. Specifically, as a length of a first extension portion 221 is relatively longer, an area of the first extension portion 221 coupled to a second winding portion 310 may increase. To this end, the first extension portion 221 may be implemented to conform to both a curved region R and a planar region P, among external side surfaces adjacent to the second winding portion 310. Similarly, a fourth extension portion 322 may be implemented to conform to both a curved region R and a planar region P, among external side surfaces adjacent to a first winding portion 210, to increase a coupling area between the third extension portion 321 and the first winding portion 210. In this case, as lengths of the extension portions 221, 222, 321, and 322 increase and regions exposed externally move onto an inner side of a body 110, external electrodes 411, 412, 421, and 422 may be disposed closer onto the inner side of the body 110, compared to the previous embodiments. As in this modified example, when a coupling area between the first extension portion 221 and the second winding portion 310 and a coupling area between the fourth extension portion 322 and the first winding portion 210 increase, since coupling of the first and second winding portions 210 and 310 may be further attenuated, a magnitude of a coupling coefficient may be further reduced as a whole in the first and second coil portions C1 and C2.

The inventors of the present disclosure have calculated a coupling coefficient by simulation for two types of coil portions, to examine an effect effectuated when the coupling area increases, as in the embodiments of FIGS. 15 and 16, and one is of the previous embodiment (FIGS. 2 and 3), and the other one has the structure of the present modified example (FIGS. 15 and 16) . The two types of coil components had a 1210 size, i.e., 12 µm and 10 µm in length and width, respectively, and 0.5 µm in thickness. Moreover, in the modified example of FIGS. 15 and 16, the extension portion was extended by about 149.5 µm and moved to an inner side of the body. As a result of the experiment, inductance (Lₛ), direct current resistance (R_{dc}) , and saturation current (Iₛₐₜ), characteristics of the two types of coil portions, showed similar levels within the target characteristics. With regard to a coupling coefficient, a magnitude of the coupling coefficient was further reduced to -0.001 in the case of having the coil portion of FIGS. 2 and 3, and 0.011 in the case of having the coil portion of FIGS. 15 and 16. As such, in this modified example, it was confirmed that an effect of reducing a magnitude of the coupling coefficient was maximized by adjusting lengths of the extension portions 221, 222, 321, and 322.

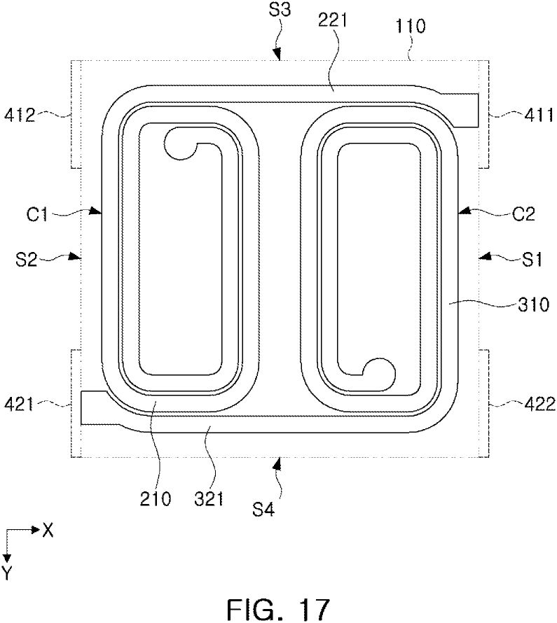

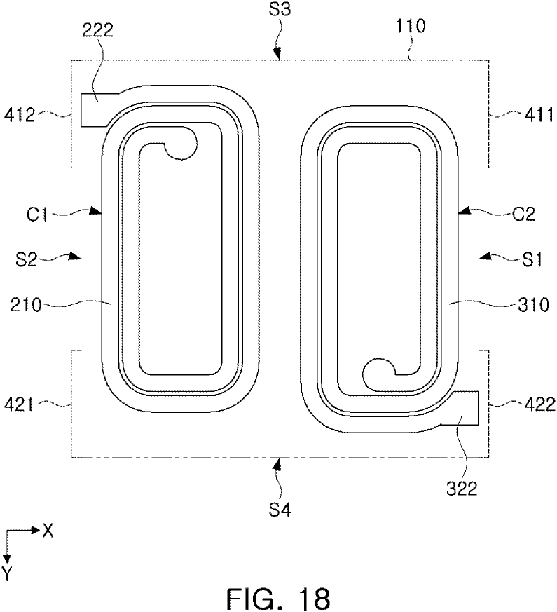

Next, in a modified example of FIG. 17 (an upper coil portion) and FIG. 18 (a lower coil portion), a shape of a first coil portion C1 is identical to that illustrated in FIGS. 2 and 3, and a shape of a second coil portion C2 is different from that illustrated in FIGS. 2 and 3. Specifically, the shape of the second coil portion C2 may be deformed such that a third extension portion 321 in the upper coil portion (FIG. 17) extends to a second side surface S2 and is connected to a third external electrode 421, and, a fourth extension portion 322 in the lower coil portion (FIG. 18) extends to a first side surface S1 and is connected to a fourth external electrode 422. As the second coil portion C2 has such a connection method, based on current flow of the first coil portion C1 from a first extension portion 221 toward a second extension portion 222 and current flow of the second coil portion C2 from a third extension portion 321 to a fourth extension portion 322, coupling between the first extension portion 221 and the second winding portion 310 and coupling between the third extension portion 321 and the first winding portion 210 may be adjusted to occur only in the upper coil portion (FIG. 17), and only coupling between the first and second winding portions 210 and 310 may be adjusted to occur in the lower coil portion (FIG. 18).

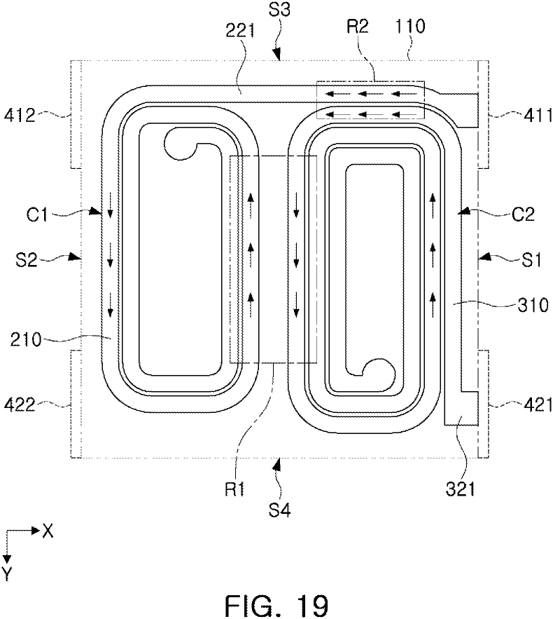

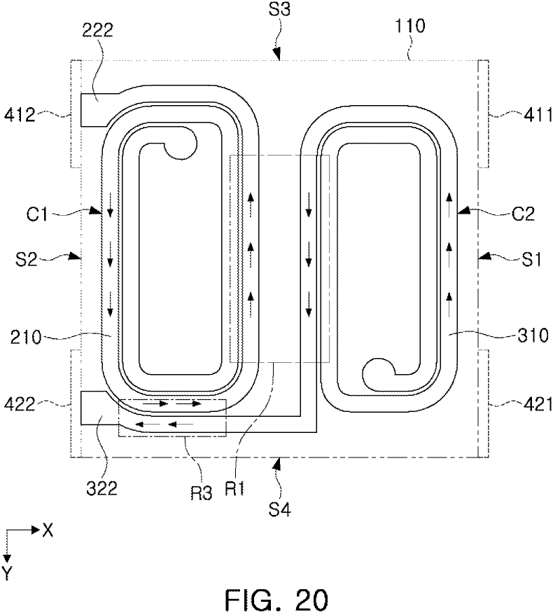

Next, in a modified example of FIG. 19 (an upper coil portion) and FIG. 20 (a lower coil portion), a shape of a first coil portion C1 is identical to that illustrated in FIGS. 2 and 3, and a shape of a second coil portion C2 is different from that illustrated in FIGS. 2 and 3. Specifically, a direction of a turn of the second coil portion C2 is different from that of the previous embodiment, and accordingly, a manner in which coupling occurs is also different from that of the previous embodiment. Based on current flow of the first coil portion C1 from a first extension portion 221 toward a second extension portion 222 and current flow of the second coil portion C2 from a third extension portion 321 to a fourth extension portion 322, negative coupling may occur in a first region R1 adjacent to the first and second winding portions 210 and 310, and positive coupling may occur in a second region R2 adjacent to the first extension portion 221 and the second winding portion 310. Contrary to the second region R2, negative coupling may occur in a third region R3 adjacent to the fourth extension portion 322 and the first winding portion 210. The modified example could be applied in an inductor array designed to require relatively more negative coupling.

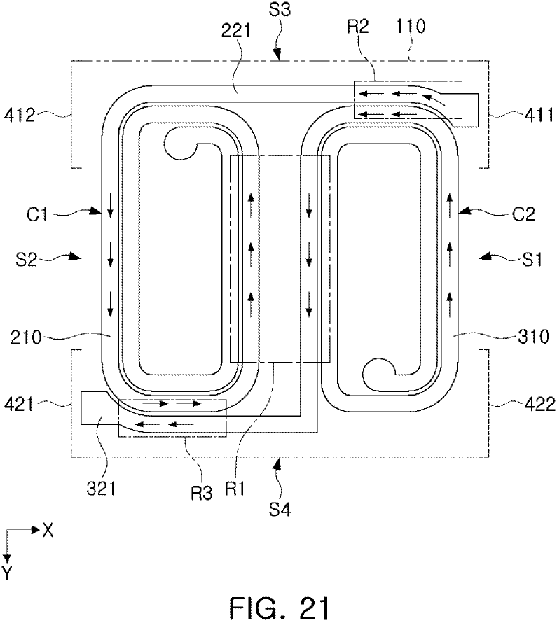

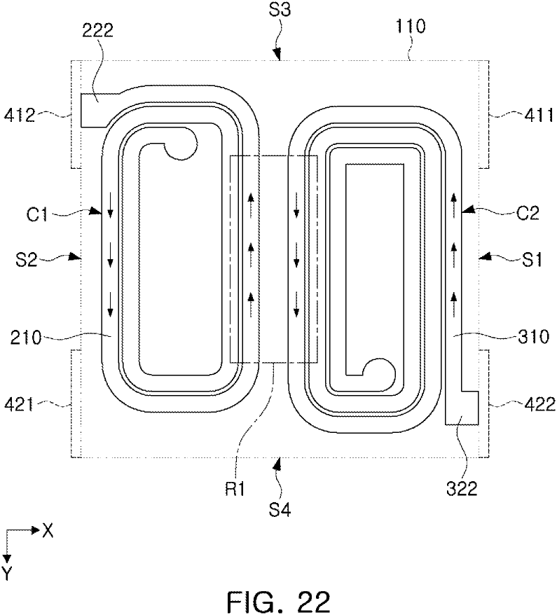

Next, in a modified example of FIG. 21 (an upper coil portion) and FIG. 22 (a lower coil portion), a shape of a first coil portion C1 is identical to that illustrated in FIGS. 2 and 3, and a shape of a second coil portion C2 is different from that illustrated in FIGS. 2 and 3. Specifically, a direction of a turn of the second coil portion C2 is different from that of the previous embodiment, and accordingly, a manner in which coupling occurs is also different from that of the previous embodiment. Based on current flow of the first coil portion C1 from a first extension portion 221 toward a second extension portion 222 and current flow of the second coil portion C2 from a third extension portion 321 to a fourth extension portion 322, negative coupling may occur in a first region R1 adjacent to first and second winding portions 210 and 310, and positive coupling may occur in a second region R2 adjacent to the first extension portion 221 and the second winding portion 310. Contrary to the second region R2, negative coupling may occur in a third region R3 adjacent to the third extension portion 321 and the first winding portion 210. The modified example could be applied to an inductor array designed to require relatively more negative coupling, and a difference from the modified examples of FIGS. 19 and 20 is that shapes of the upper coil portion and the lower coil portion in the second coil portion C2 are arranged opposite to each other. Therefore, in the present modified example, coupling between the first and second winding portions 210 and 310 in the upper coil portion (FIG. 21), coupling between the first extension portion 221 and the second winding portion 310, and coupling between the third extension portion 321 and the first winding portion 210 may occur, and coupling between the first and second winding portions 210 and 310 may occur in the lower coil portion.

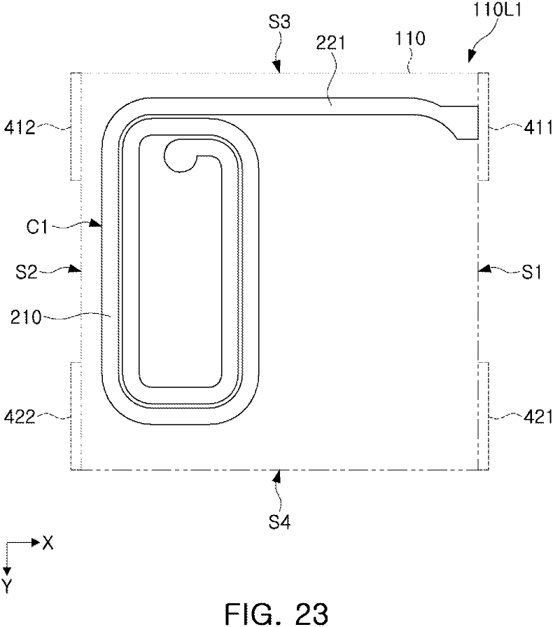

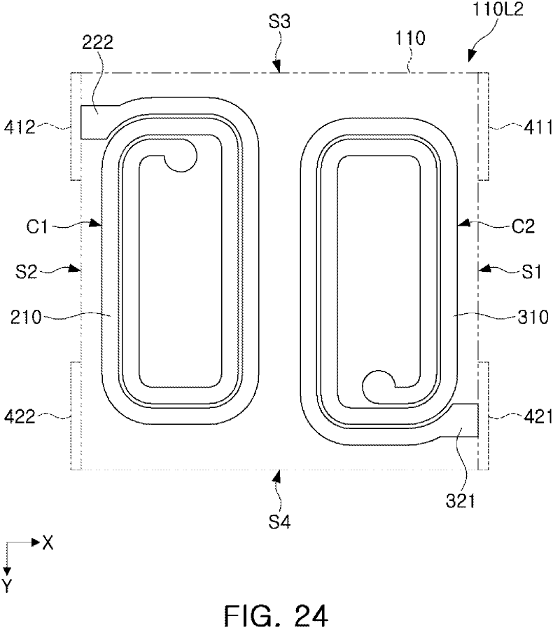

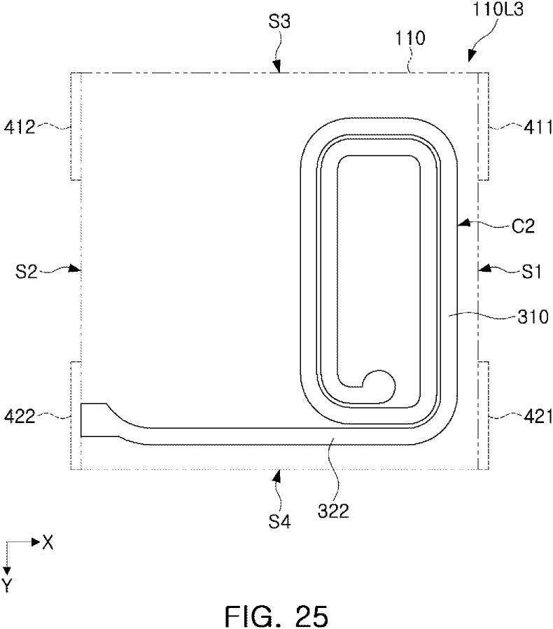

Next, in a modified example of FIGS. 23 to 25, a coil portion may have a stack structure having a number of layers greater than two (2). In the present modified example, it may be effectively used when it is necessary to reduce an area occupied by a coil portion on a single level. As illustrated in FIGS. 23 to 25, first and second coil portions C1 and C2 may be disposed on at least three levels in a body 110, and in the present modified example, may be disposed on three levels. In this case, FIG. 23 corresponds to an uppermost level, FIG. 25 corresponds to a lowermost level, and FIG. 24 corresponds to an intermediate level therebetween. For example, the three levels within the body 110 may include first to third levels 110L1, 110L2, and 110L3, and the second level 110L2 may be disposed between the first level 110L1 and the third level 110L3. In addition, the first coil portion C1 may be disposed on the first and second levels 110L1 and 110L2, and the second coil portion C2 may be disposed on the second and third levels 110L2 and 110L3. In the present modified example, coupling between the first and second coil portions C1 and C2 may not occur only on the same level, and coupling between a first extension portion 221 and a second winding portion 310 may occur over the first level 110L1 and the second level 110L2. Similarly, coupling between a fourth extension portion 322 and a first winding portion 210 may occur over the second level 110L2 and the third level 110L3. In addition, coupling between the first winding portion 210 and the second winding portion 310 may mainly occur on the second level 110L2. Coupling occurring in the first and second coil portions C1 and C2, other than cases in which three or more levels are used, may be substantially equal to in the embodiment described in FIGS. 2 and 3, and the present modified example may be applied to other embodiments, in addition to FIGS. 2 and 3.

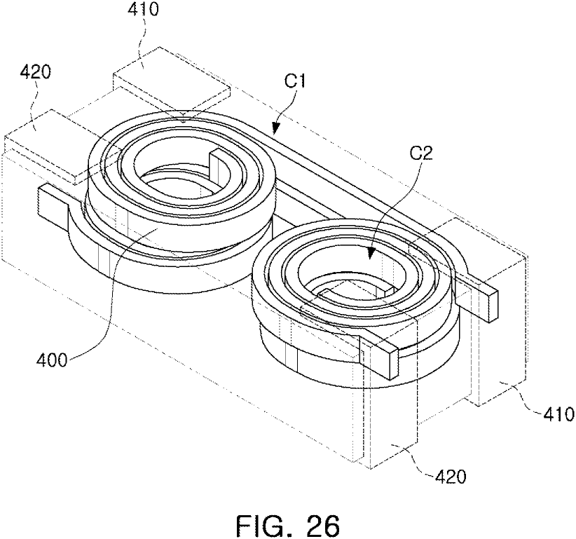

Next, a modified example of FIG. 26 may be different from the embodiment described in FIGS. 2 and 3 in view of the fact that only a winding coil 400 is used for first and second coil portions C1 and C2, and may be substantially equal to the embodiment described in FIGS. 2 and 3 in view of coupling occurring in first and second coil portions C1 and C2. Moreover, the winding coil of the modified example may be applied to all of the above-described embodiments. The winding coil may be formed by winding a metal wire such as a copper wire (Cu-wire) including a metal line and a coating layer covering a surface of the metal line. Therefore, an entire surface of each of a plurality of turns of the winding coil 400 may be covered with the coating layer. The metal wire may be a rectangular wire, but the present disclosure is not limited thereto. When the winding coil 400 is formed with the rectangular wire, a cross-section of each turn may have a rectangular shape. In addition, the coating layer may include, but not limited to, epoxy, polyimide, a liquid crystal polymer, or the like, alone or in combination. Even when the coil portions C1 and C2 are implemented using a winding coil as in the present modified example, at least a portion of regions adjacent to each other exhibit opposite coupling patterns, to effectively reduce a magnitude of a coupling coefficient.

In a coil component according to an embodiment of the present disclosure, a magnitude of a coupling coefficient may be effectively reduced without increasing a distance between a plurality of coil portions.

While example embodiments have been illustrated and described above, it will be apparent to those skilled in the art that modifications and variations could be made without departing from the scope of the present disclosure as defined by the appended claims.

What is claimed is:

1. A coil component comprising:
a body including first and second side surfaces perpendicular to a first direction while opposing each other, with third and fourth side surfaces opposing each other while connecting the first and second side surfaces;
a first coil portion disposed in the body, and including a first winding portion as well as first and second extension portions, respectively connected to one end and the other end of the first winding portion;
a second coil portion disposed in the body, and including a second winding portion disposed between the first side surface and the first winding portion, and third and fourth extension portions respectively connected to one end and the other end of the second winding portion;
first and second external electrodes disposed on the body and respectively connected to the first and second extension portions; and
third and fourth external electrodes disposed on the body and respectively connected to the third and fourth extension portions,
wherein the first extension portion of the first coil portion is disposed between the second winding portion and one of the third and fourth side surfaces, and is connected to the first external electrode on at least one of the first side surface and the third side surface.

2. The coil component of claim 1, wherein a second direction, which is perpendicular to the third side surface and the fourth side surface, is perpendicular to the first direction.

3. The coil component of claim 2, wherein the first extension portion and the second winding portion are disposed in the second direction.

4. The coil component of claim 1, wherein, based on current flow of the first coil portion from the first extension portion toward the second extension portion, and current flow of the second coil portion from the third extension portion toward the fourth extension portion, positive coupling between the first coil portion and the second coil portion occurs in a first region including at least a region between the first and second winding portions.

5. The coil component of claim 1, wherein, based on current flow of the first coil portion from the first extension portion toward the second extension portion, and current flow of the second coil portion from the third extension portion toward the fourth extension portion, negative coupling between the first coil portion and the second coil portion occurs in a second region including at least a region between the first extension portion and the second winding portion.

6. The coil component of claim 1, wherein, based on current flow of the first coil portion from the first extension portion toward the second extension portion, and current flow of the second coil portion toward the fourth extension portion from the third extension portion, coupling between the first coil portion and the second coil portion opposite to coupling occurring in a second region including at least a region between the first extension portion and the second winding portion occurs in a first region including at least a region between the first and second winding portions.

7. The coil component of claim 1, wherein an interval between the first winding portion and the second winding portion in the first region is wider than an interval between the first extension portion and the second winding portion in the second region.

8. The coil component of claim 7, wherein an interval between the first extension portion and the second winding portion in the second region is substantially equal to an interval between adjacent turns in the second winding portion.

9. The coil component of claim 6, wherein, in the second region, the first extension portion has an inner side surface having a shape conforming to a shape of an external side surface adjacent to the second winding portion.

10. The coil component of claim 9, wherein the first extension portion has a shape conforming to both a curved region and a planar region on the external side surface adjacent to the second winding portion.

11. The coil component of claim 2, wherein the fourth extension portion extends to at least one of the second side surface and the fourth side surface, and is disposed between the first winding portion and another of the third and fourth side surfaces.

12. The coil component of claim 11, wherein the fourth extension portion and the first winding portion are disposed in the second direction.

13. The coil component of claim 1, wherein, based on current flow of the first coil portion from the first extension portion toward the second extension portion, and current flow of the second coil portion from the third extension portion toward the fourth extension portion, negative coupling between the first coil portion and the second coil portion occurs in a first region including at least a region between the first and second winding portions.

14. The coil component of claim 13, wherein positive coupling between the first coil portion and the second coil portion occurs in a second region including at least a region between the first extension portion and the second winding portion.

15. The coil component of claim 14, wherein positive coupling between the first coil portion and the second coil portion occurs in a third region including at least a region between the fourth extension portion and the first winding portion.

16. The coil component of claim 14, wherein negative coupling between the first coil portion and the second coil portion occurs in a third region including at least a region between the fourth extension portion and the first winding portion.

17. The coil component of claim 1, further comprising a support member supporting the first and second coil portions,
wherein the first coil portion is disposed on upper and lower surfaces of the support member, and
the second coil portion is disposed on the upper and lower surfaces of the support member.

18. The coil component of claim 17, wherein the first and third extension portions are disposed on the upper surface of the support member, and
the second and fourth extension portions are disposed on the lower surface of the support member.

19. The coil component of claim 18, wherein the second extension portion is connected to the second external electrode on at least one of the first side surface and the third side surface of the body.

20. The coil component of claim 18, wherein the third extension portion is connected to the third external electrode on at least one of the first side surface and the fourth side surface of the body, and
the fourth extension portion is connected to the fourth external electrode on at least one of the second side surface and the fourth side surface of the body.

21. The coil component of claim 18, wherein lengths of the first and second extension portions are different from each other in the first direction.

22. The coil component of claim 17, wherein, in the first and second coil portions, those disposed on the upper surface of the support member is symmetrical to those disposed on the lower surface of the support member, based on the support member.

23. The coil component of claim 1, wherein the first and second coil portions are disposed on at least three levels within the body.

24. The coil component of claim 23, wherein the at least three levels comprise first to third levels,
wherein the second level is located between the first level and the third level,
the first coil portion is disposed on the first and second levels, and
the second coil portion is disposed on the second and third levels.

25. A coil component comprising:
a body including first and second side surfaces perpendicular to a first direction while opposing each other, with third and fourth side surfaces opposing each other while connecting the first and second side surfaces;
a first coil portion disposed in the body, including a first winding portion as well as first and second extension portions, respectively connected to one end and the other end of the first winding portion;
a second coil portion disposed in the body, and including a second winding portion disposed between the first winding portion and the first side surface, and third and fourth extension portions respectively connected to one end and the other end of the second winding portion;
first and second external electrodes disposed on the body and respectively connected to the first and second extension portions; and
third and fourth external electrodes disposed on the body and respectively connected to the third and fourth extension portions,
wherein the first extension portion extends toward at least one of the first side surface and the third side surface, to be connected to the first external electrode,
wherein, based on current flow of the first coil portion from the first extension portion toward the second extension portion, and current flow of the second coil portion from the third extension portion toward the fourth extension portion, opposite coupling between the first and second coil portions occurs in at least two regions among a plurality of regions between the first and second coil portions.

26. The coil component of claim 25, wherein coupling between the first and second coil portions opposite to coupling occurring in a second region including at least a region between the first extension portion and the second winding portion occurs in a first region including at least a region between the first and second winding portions.

27. A coil component comprising:
a body;
a first coil portion disposed in the body and including a first winding portion;
a second coil portion disposed in the body and including a second winding portion;
first and second external electrodes disposed on exterior surfaces of the body and connected to the first coil portion; and
third and fourth external electrodes disposed on the exterior surfaces the body and connected to the second coil portion,
wherein one of the first and second external electrodes is closer to the second winding portion than one of the third and fourth external electrodes and farther to the first winding portion than the one of the third and fourth external electrodes, and
another of the first and second external electrodes is closer to the first winding portion than another of the third and fourth external electrodes and farther to the second winding portion than the another of the third and fourth external electrodes.

28. The coil component of claim 27, wherein the body includes first and second side surfaces opposing each other in a first direction, and third and fourth side surfaces opposing each other in a second direction and connecting the first and second side surfaces, and
the second winding portion is disposed between the first winding portion and the first side surface, and the first winding portion is disposed between the second winding portion and the second side surface.

29. The coil component of claim 28, wherein the first and second external electrodes are closer to one of the third and fourth surfaces than the third and fourth external electrodes.

30. The coil component of claim 27, further comprising a support member,
wherein the first winding portion includes one winding portion disposed on an upper surface of the support member and another winding portion disposed on a lower surface of the support member and connected to the one winding portion of the first winding portion, and
the second winding portion includes one winding portion disposed on the upper surface of the support member and another winding portion disposed on the lower surface of the support member and connected to the one winding portion of the second winding portion.

31. A coil component comprising:
a body including first and second side surfaces opposing each other and third and fourth side surfaces opposing each other while connecting the first and second side surfaces;
a first coil portion disposed in the body and including a first winding portion;
a second coil portion disposed in the body and including a second winding portion disposed between the first side surface and the first winding portion;
first and second external electrodes disposed on the body and connected to the first coil portion; and
third and fourth external electrodes disposed on the body and connected to the second coil portion,
wherein a path along the first coil portion from one of the first and second external electrodes to another of the first and second external electrodes, and a path along the second coil portion from one of the third and fourth external electrodes to another of the third and fourth external electrodes, are in a same direction at a region between center portions of the first and second winding portions and are in opposite directions at a region between the center portion of one of the first and second winding portions and one of the third and fourth surfaces.

32. The coil component of claim 31, wherein the first and second external electrodes are closer to one of the third and fourth surfaces than the third and fourth external electrodes.

33. The coil component of claim 32, wherein the first and third external electrodes are closer to the first side surface than the second and fourth external electrodes.

34. The coil component of claim 31, further comprising a support member,
wherein the first winding portion includes one winding portion disposed on an upper surface of the support member and another winding portion disposed on a lower surface of the support member and connected to the one winding portion of the first winding portion, and
the second winding portion includes one winding portion disposed on the upper surface of the support member and another winding portion disposed on the lower surface of the support member and connected to the one winding portion of the second winding portion.
